(19) United States
(12) Patent Application Publication
(10) Pub. No.: US 2012/0029689 A1
(43) Pub. Date: Feb. 2, 2012

(54) LOAD-DEPENDENT ROUTING IN MATERIAL FLOW SYSTEMS

(76) Inventors: Georg Baier, Munchen (DE); Konstantin Keutner, Neubiberg (DE)

(21) Appl. No.: 13/263,269

(22) PCT Filed: Mar. 10, 2010
(86) PCT No.: PCT/EP10/53013

§ 371 Date: Oct. 6, 2011

(30) Foreign Application Priority Data
Apr. 6, 2009 (DE) 10 2009 016 578.9
Apr. 20, 2009 (DE) 10 2009 018 092.3
Jul. 17, 2009 (DE) 10 2009 033 600.1

(51) Int. Cl. B65G 43/00; B65G 43/10; G05B 19/418; G06F 19/00

(52) U.S. Cl. 700/230

(57) ABSTRACT

In a method for determining the route of transport units, especially in material flow systems (e.g. luggage conveyor systems in airports), a prognosis is established as to how many transport units arrive at each module (e.g. points, conveyor track) within a window of time, an evaluation function is defined based on the prognosis for each module, an edge weight is allocated to each module according to its load predicted in the window of time, and a route is determined for each transported unit (e.g. piece of luggage) in a temporally successive manner. The method enables an automation of the fine adjustment (tuning) of an installation according to the current and expected load situation.

### CROSS-REFERENCE TO RELATED APPLICATIONS

This application is a U.S. National Stage Application of International Application No. PCT/EP2010/053013 filed Mar. 10, 2010, which designates the United States of America, and claims priority to German Application No. 10 2009 016 578.9 filed Apr. 6, 2009; German Application No. 10 2009 018 092.3 filed Apr. 20, 2009 and German Application No. 10 2009 033 600.1 filed Jul. 17, 2009. The contents of which are hereby incorporated by reference in their entirety.

### TECHNICAL FIELD

The invention relates to methods for determining the route of transported units, particularly in material flow systems. The invention also relates to a device and a material flow system for carrying out said methods.

### BACKGROUND

Material flow systems should, as far as possible, achieve the optimum throughput of the goods to be transported. For this purpose, material flow decisions such as the settings of points or whether new transported goods are to be loaded must be made such that unbalanced loads and jams do not arise. For this purpose, the current loading state of the installation and, if available, information on the transported goods planned to be loaded can be used for a prediction of regions of the installation where jams, etc., can be expected. These can then be counteracted with suitable control strategies.

Large material flow installations, for example, in airports, have a very complex structure and are also subject to constantly changing transport requirements. In an airport, the volume of passengers and thus also of luggage is very unevenly distributed throughout the day and over the days of the week. Nevertheless, the material flow installation needs to achieve a high throughput at any time. One important possibility for influencing the performance of the installation is the selection of a suitable route to fulfill a transport task. The route is determined by choosing the direction of a transported unit at a set of points. This choice is made, for example, by means of routing tables, at the points.

Conventional material flow installations have control devices which determine the direction depending on the destination of the transported unit. This decision is usually stipulated by the routing tables at the points.

Adjustment of a material flow installation (e.g. a luggage conveyor in an airport) before commissioning, i.e. which routing tables the material flow computer should distribute to the control devices under which installation states, involves a significant effort because different loading scenarios must be determined and tested for the installation.

### SUMMARY

According to various embodiments, methods for determining routes of transported units in material flow systems can be provided which require minimum effort for commissioning the material flow system.

According to an embodiment, a method for determining the route of transported units, particularly in material flow systems, may comprise the following steps: a) Modeling the material flow system in modules which each represent physical elements of the material flow system, wherein a number of transported units that should reach a module within a specifiable time window is assigned to said module; b) Making a prediction of how many transported units arrive at each module within the time window; c) Creating an evaluation function based on the prediction for each module, wherein an edge weight is assigned to each module, depending on the predicted load thereof within the time window; and wherein d) For each transported unit, sequentially, a route is determined, wherein the route is the shortest possible path, based on the edge weight of the module.

According to a further embodiment, each transported unit can be assigned a route in chronological sequence. According to a further embodiment, each transported unit can be assigned a route in chronological sequence, based on the values from the routing tables assigned to the modules, wherein each routing table is dependent on the time. According to a further embodiment, the method can be repeated at irregularly clocked intervals. According to a further embodiment, the prediction can be made based on a cyclical information process and an exponential decay process. According to a further embodiment, for the prediction creation, the current route of a transported unit can be fixed in a specifiable clock rhythm and that for all modules along the route, in the expected arrival time window for the transported unit, the prediction is increased by 1, and wherein, in the specified clock rhythm, for all modules, the prediction is multiplied by 0.5. According to a further embodiment, for the prediction creation, the current route of a transported unit can be fixed in a specifiable clock rhythm and for all the modules along the route, in the expected arrival time window for the transported unit, the prediction is increased by 1, and wherein, in the specified clock rhythm, for all modules the prediction is multiplied in chronological order with values s₁ to sₖ, where 0.5<sᵢ<1 (i=1 . . . k), and the product s₁* . . . *sₖ is equal to 0.5. According to a further embodiment, the evaluation function for creating the edge weight can be made up from an expected standard passage time of a transported unit to be expected at the module and a penalty component per module, which is determined from the predicted number of transported units in the expected entry time window of the transported unit at the module. According to a further embodiment, the shortest route for a transported unit can be determined by the A* algorithm, the Dijkstra algorithm, the Bellman-Ford algorithm, the Floyd-Warshall algorithm or the Johnson algorithm. According to a further embodiment, a shorter or the shortest route for a transported unit can be determined, based on distributed algorithms for determining or approximating shortest routes. According to a further embodiment, a module may consist of a self-contained unit with regard to actuators, sensors and control device and comprises an internal simulator for determining a capacity utilization prediction for the module, wherein the module can exchange data with the predecessor and successor modules thereof, and wherein the capacity utilization prediction for the module is calculated on the basis of the entry time points of the transported units to the module supplied by the predecessor modules. According to a further embodiment, the module may pass on to the successor modules the time points of the exit from the module of the transported units as predicted by the internal simulator.

According to another embodiment, a method for determining routes of transported units, particularly in material flow systems, may comprise the following steps: a) Modeling the material flow system in modules, each of which represents physical elements of the material flow system, wherein a time-dependent routing table is assigned to a module, wherein, for each destination point of a transported unit, the routing table contains the next module on the route to the destination, or the information that the destination point cannot be reached; and b) Updating the routing tables.

According to a further embodiment of the above method, the updating of the routing tables can be carried out with precise or approximate algorithms for determining the shortest route. According to a further embodiment of the above method, the updating of the routing tables can be carried out by internal simulation. According to a further embodiment of the above method, the time-dependent routing table can be characterized in that the information concerning the next module on the route to the target is dependent on the time point at which the transported unit is to be passed on to said module.

According to yet another embodiment, a device may be configured to carry out a method as described above.

According to yet another embodiment, a material flow system may be suitable for carrying out a method as described above.

### BRIEF DESCRIPTION OF THE DRAWINGS

An exemplary embodiment will now be described in detail, making reference to the drawings, in which:

FIG. 1 is an illustration of an exemplary architecture for the use of decentralized control components making use of internal simulators,

FIGS. 2A-2B is an example of an installation with modules of a material flow system,

FIG. 3 is an example of a first occupation state of the installation of FIGS. 2A-2B,

FIG. 4 is an example of a second occupation state of the installation of FIGS. 2A-2B,

FIG. 5 is an example of a third occupation state of the installation of FIGS. 2A-2B, and

FIG. 6 is an example of a prediction time window of modules m₁ and m₂.

### DETAILED DESCRIPTION

According to various embodiments, a method for determining the routes of transported units, particularly in material flow systems, may comprise the following steps:
a) Modeling the material flow system in modules which each represent physical elements of the material flow system, wherein a number of transported units that should reach a module within a specifiable time window is assigned to said module;
b) Making a prediction of how many transported units arrive at each module within the time window; and
c) Creating an evaluation function based on the prediction for each module, wherein an edge weight is assigned to each module, depending on the predicted load thereof within the time window; and wherein
d) For each transported unit, sequentially, a route is determined, wherein the route is the shortest possible path, based on the edge weight of the modules. The method enables automation of the fine adjustment (tuning) of an installation, depending on the actual and expected load situations. Since the installation no longer needs to be adjusted based on expected loading scenarios (i.e. suspected load situations), errors in the selection of the loading scenarios for adjustment can be prevented. The selection of the loading scenarios no longer takes place by trial and error using suspected load situations. The method is adaptive (to changing installation states) and requires no knowledge of expected loading data. The planned routes of the transported units are determined from the actual or expected installation state and can change over time. With this self-configuration (self-setting) of the installation, the commissioning effort and costs are reduced. In a decentralized installation, the self-configuration enables the installation to “plug and convey”.

A first embodiment lies in each transported unit being assigned a route in chronological sequence. By this means, the route of a transported unit in the material flow system is still adjustable dynamically.

A further embodiment lies in each transported unit being assigned a route in chronological sequence, based on the values from the routing tables assigned to the modules, wherein each routing table is dependent on the time. Thus, for a particular destination point, it can be stipulated, differentiated over time, which routes to this destination point are used. A material flow computer is not necessary for this. This results in relieving of the workload on the material flow computer.

A further embodiment lies in the method being repeated at irregularly clocked intervals. This means that no synchronization effort is required to be made in decentralized installations. This also prevents oscillation in the installation.

A further embodiment lies in the prediction being made on the basis of a cyclical information process and an exponential decay process. In this way, an explicit reservation and clearance process can be dispensed with, so that throughput is increased. Installations with explicit reservations and clearances tend to have a low throughput.

A further embodiment lies in the fact that, for the prediction creation, the current route of a transported unit is fixed in a specifiable clock rhythm and that for all modules along the route, in the expected arrival time window for the transported unit, the prediction is increased by 1, and wherein, in the specified clock rhythm, the prediction is multiplied by 0.5 for all modules.

A further embodiment lies in the fact that, for the prediction creation, the current route of a transported unit is fixed in a specifiable clock rhythm and for all the modules along the route, in the expected arrival time window for the transported unit, the prediction is increased by 1, and wherein, in the specified clock rhythm, the prediction is multiplied for all modules in chronological order with values s₁ to sₖ, where 0.5<sᵢ<1 (i=1 . . . k), and the product s₁* . . . *sₖ is equal to 0.5. By this means, a smoothing of the decay process is achieved which is simple to realize.

A further embodiment lies in the fact that the evaluation function for creating the edge weight is made up from an expected standard passage time of a transported unit at the module and a penalty component per module, which is determined from the predicted number of transported units in the expected entry time window of the transported unit at the module. The evaluation function is made up of two parts, namely the expected standard passage time of a transported unit through the module and a waiting or penalty time dependent on the load. The precise configuration of the evaluation function is dependent on the actual module, but must be matched to all the modules of an installation. The evaluation function is based on two parameters (expected standard passage time and penalty component). This enables the material flow system to operate in a state below the maximum load, i.e. all modules have a prediction that is smaller than the maximum load thereof at all future time points. Jams and unbalanced loads are thus prevented.

A further embodiment lies in the shortest route for a transported unit being determined by the A* algorithm, the Dijkstra algorithm, the Bellman-Ford algorithm, the Floyd-Warshall algorithm or the Johnson algorithm. These standard algorithms can easily be implemented on control computers for the installation.

A further embodiment lies in a shorter or the shortest route for a transported unit being determined based on distributed algorithms for determining or approximating shortest routes. This simplifies integration in decentralized material flow systems.

A further embodiment lies in a module consisting of a self-contained unit with regard to actuators, sensors and control device and comprises an internal simulator for determining a capacity utilization prediction for the module, wherein the module can exchange data with the predecessor and successor modules thereof, and wherein the capacity utilization prediction for the module is calculated on the basis of the entry time points of the transported units to the module supplied by the predecessor modules. This simplifies the integration into decentralized material flow systems and simplifies the installation configuration during engineering based on technological objects which represent the modules of the installation in software.

A further embodiment lies in the module passing on to the successor module the time points of the exit from the module of the transported units as predicted by the internal simulator. This simplifies the integration into decentralized material flow installations and enables the self-configuration of the installation.

The problem is also solved with a method for determining routes of transported units, particularly in material flow systems, comprising the following steps:
a) Modeling the material flow system in modules, each of which represents physical elements of the material flow system, wherein a time-dependent routing table is assigned to a module, wherein, for each destination point of a transported unit, the routing table contains the next module on the route to the destination, or the information that the destination point cannot be reached; and
b) Updating the routing tables. The updating of the routing tables can take place according to a particular time pattern (clocked or cyclically), or asynchronously. Thus, for a particular destination point, it can be stipulated in a chronologically differentiated manner which routes to this destination point are used. A material flow computer is not needed therefor. The routing tables are always adapted to the new load situation. The method also enables automation of the fine adjustment (tuning) of an installation according to the current and expected load situation.

A further embodiment lies in the updating of the routing tables being carried out with precise or approximate algorithms for determining the shortest route. For example, the following algorithms can be used: the A* algorithm, Dijkstra algorithm, Bellman-Ford algorithm, Floyd-Warshall algorithm or the Johnson algorithm. Standard programs exist for these algorithms and they can easily be implemented on computer systems or control devices.

A further embodiment lies in the updating of the routing tables being carried out by internal simulation. This is advantageous in the creation of decentralized algorithms.

A further embodiment lies in the time-dependent routing table being characterized in that the information concerning the next module on the route to the destination is dependent on the time point at which the transported unit is to be passed on to said module. The routes that will be used to said destination point can therefore be stipulated in time-differentiated manner for a particular destination point.

The problem is also solved with a device and a material flow system suitable for carrying out the methods. The methods can be implemented in installations with standard components (points, conveyor belts, etc.) and based on standard hardware. For communication, cable connections (e.g. LAN, Ethernet) or wireless connections (e.g. WLAN) can be used and, as computer units, control devices (PLC) or, for example, industrial PCs can be used.

Large material flow systems such as those in airports have a very complex structure and are also subject to constantly changing transport requirements. In an airport, the volume of passengers and thus also of luggage is very unevenly distributed throughout the day and over the days of the week. Nevertheless, the material flow installation needs to achieve a high throughput in each case. One important possibility for influencing the performance of the installation is the selection of a suitable route to fulfill a transport task. The route is determined by choosing the direction of a transported unit at a set of points. This choice is usually made by means of routing tables at the points. I.e. depending on the destination of the transported unit, the route to be selected by the points is stored in the table.

In order to prevent the occurrence of unbalanced loads in such installations with complex topologies and greatly varying loading profiles, said routing tables are updated according to the installation situation. In general, this problem is taken over by a higher-order central material flow computer.

Conventional material flow systems have control devices which determine the direction depending on the destination of the transported unit. This decision is made by a routing table. At a set of points, the destination can, under certain circumstances, be reached via both alternate routes. In such cases, the direction decision can also be given as a ratio between the right-hand and the left-hand route. A ratio of 2:1 means that, with the same destination, two transported units will always be deflected to the left and then one to the right. The material flow computer is tasked with updating these tables such that the installation is always operated in an effective state, depending on the current situation. For this purpose, the material flow computer, as the central device, obtains from the subordinate control devices the updated information on the installation state. Adjustment before commissioning of the material flow system as to which routing tables the material flow computer should distribute to the control devices under which installation states, involves a significant workload, since the different loading scenarios must be determined and tested (installation tuning).

The method according to various embodiments, however, is based on the creation of a chronologically differentiated prediction concerning the number of transported units expected for a conveying element (module), for example, conveyor belt, set of points or junction.

For each transported unit to be carried, a route is determined based on a shortest path (possibly with auxiliary conditions). The evaluation function for determining the path length is dependent on the expected load of the modules included on the path, as per the prediction. The time is divided into discrete time windows of equal size. The prediction made always relates to the number of transported units in a time window.

Generation of the Prediction

The basis for generating the prediction is the allocation of a route to each transported unit (in fact a route does not have to be allocated to one transported unit; two transported units that are chronologically close to one another with the same destination can swap the remaining routes thereof on a common module). Due to the linking of a route to the transported unit, the expected entry time point of the transported unit to the modules along the route can be determined. The transported unit can then be taken into account in the associated time window in the prediction for the module. However, the prediction does not represent an attempt to determine precisely the transported units fitting within a module. The system is in particular not a reservation/clearance mechanism. The prediction is modeled with the aid of a cyclic information process and an exponential decay process. This means that, in a fixed rhythm, for each transported unit, the information that a transported unit will arrive at the calculated time point is sent to the modules of the path assigned to the transported unit. The prediction values of the modules on the number of transported units expected within a time window are scaled by ½ in the same rhythm. In order to prevent the sudden halving, the decay process can be more continuously implemented, e.g. multiplication by

$$1 / \sqrt[n]{2}$$

n times within a cycle. If the route assigned to a transported unit is changed, then no clearance process takes place for the modules of the old route. If a module is no longer included in the new route, then the proportion with which said transported unit was previously counted at the module is reduced by half by means of scaling within a cycle. I.e. after five cycles, a proportion of 1/2⁵=0.03125 of said transported unit is still included in the prediction for said module.

If data for transport tasks to be expected in future are available, said data can also be taken into account. The expected transported unit is assigned a route like all other transported units. Only the start time point for the route changes, and instead of the current time, the expected loading time point is used.

The Evaluation Function

Based on the prediction for each module, an evaluation function is defined which assigns to each module an edge weight depending on the load thereof predicted in the observed time window. The evaluation function increases monotonically, wherein said function increases with increasing approximation to the maximum load of the module. Since, however, the prediction is not an exact forecast of the future load, the function must also be well defined and finite for values greater than the maximum load. The aim of route selection is to operate the material flow system in a state below the maximum load, i.e. all the modules have, for all future time points, a prediction smaller than the maximum load thereof. The evaluation function is made up of two parts, being the expected standard passage time of a transported unit through the module and a waiting or penalty time dependent on the load. The precise configuration of the evaluation function is dependent on the actual module, but must be matched across all the modules of an installation.

Routing

Routing, which is the selection of the actual path along which a transported unit is steered from start to destination, becomes reduced to the determination of the shortest route with regard to the load-dependent evaluation function. When determining the shortest route, other auxiliary conditions must be taken into account for the given installation, for example, based on the properties of the transported unit, individual modules can be blocked (left out) during route determination. The route determined is assigned to the transported unit and is used both for direction selection in the material flow system and for creating the prediction.

Due to the dynamic properties in the material flow system, the prediction changes continuously, as does, consequently, the evaluation function for a module. In order to take account of the changed state of the material flow system, the shortest route for a transported unit from the current position thereof to the destination is determined anew (possibly with auxiliary conditions). If the route changes, said route is assigned to the transported unit as a new route. Indirectly, due to the regular information concerning all the modules contained within the route, the prognosis values of the newly included or no longer included module change. The shortest routes should therefore not all be determined or updated for the transported units at the same time, in order to prevent the collapse of the routes.

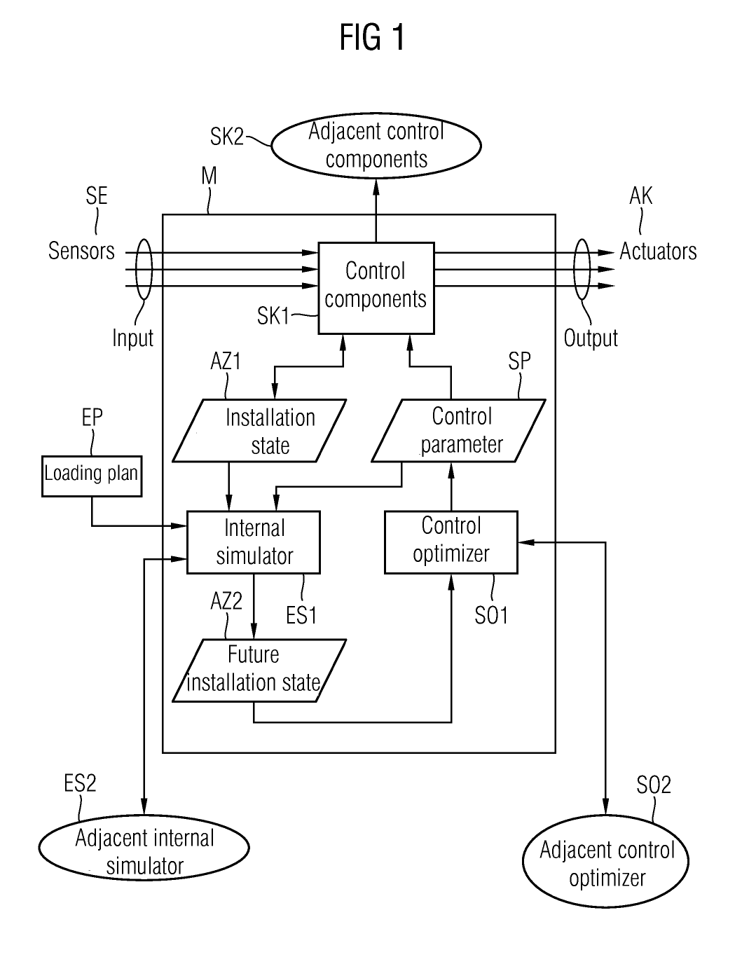

FIG. 1 shows an exemplary architecture for the use of a decentralized control component for use in decentralized material flow systems (decentralized material flow systems have no central material flow computer). In decentralized systems, using internal simulators of the decentralized control components, the creation of the prediction can be carried out efficiently and precisely.

FIG. 1 illustrates the architecture of an installation module (conveyor belt, transport route, points, etc.) with control component SK1 having an internal simulation component ES1, suitable for use in decentralized systems.

If the internal simulator ES1 gains access to the route assigned to a transported unit, or at least to the successor module ES2 in the route, then the simulator has all the necessary data to make the prediction. For illustration, we assume that the internal simulator ES1 can read the routes from the installation state AZ1 and has access to the loading plan EP. For example, the route can be stored on an RFID tag on the transported unit, and then the route is passed via the sensors SE and the control component SK1 into the installation state AZ1, to which the internal simulator ES1 has access. The internal simulator ES1 determines the effects on the prediction thereof for all the transported units relating thereto and transfers to the adjacent internal simulators ES2 the emergence time points and the routes of the transported units virtually leaving the internal simulator in the internal simulation. The internal simulator also receives from adjacent internal simulators ES2 transported units virtually arriving at said internal simulator and the routes assigned to said adjacent transported units. After reaching the maximum prediction horizon, each internal simulator ES1, ES2 has available a histogram of the transported units virtually passing said internal simulator in the near future. This histogram is the prediction of the internal simulator ES1 for the future and is entered into the future installation state AZ2.

The control optimizer SO1 must determine the paths for the transported units, based on the future installation state AZ2 predicted by the internal simulator ES1. I.e. the control optimizer SO1 must determine the shortest route from the controlled module M to a given destination in relation to the evaluation function and must be able to assign said route to a transported unit. Since the route assigned to a transported unit is to be recalculated regularly, said control optimizer also assigns a newly determined route to a validity period. The validity period can be selected varying within certain limits, in order to prevent possible oscillation.

Not only does the control optimizer SO1 have to determine a new route for a transported unit when the validity period has expired, but also when the current route has become inadmissible due to other influences, for example, due to the failure of individual modules. Based on the data supplied by the internal simulator ES1 concerning the new installation state AZ2, the control optimizer SO1 changes the control parameters SP for the control component SK1 of the installation module M. Advantageously, the control optimizer SO1 is connected to the adjacent control optimizer SO2 of the adjacent module, so that the control parameters of the adjacent modules are adjustable to the module M. This enables a rapid reaction to changing installation states.

Decentralized Route Determination

The decentralized method set out below for determining the routes finds, in principle, the shortest routes according to the evaluation function, specifically when the prediction remains stable. Since, however, this changes again based on the newly found routes, the found routes are only an approximation to the actual shortest routes under the given load. In practice, the found routes prove to be sufficiently good.

The simplest, most direct possibility is a distributed labeling algorithm with direction tables (labels) expanded with the temporal dimension. An expanded direction table for a module M contains a table for each possible destination x in the material flow system:

$${dist}_{x}^{m} = \begin{matrix}Time window & 0 & 1 & … \\ Distance & 10 & 15 & … \\ Subsequent module & {m}_{9} & {m}_{7} & …\end{matrix}$$

The table distₓ^{m} contains, for all prediction time windows beginning with the current time window, the distance to the destination and the successor module, via which this distance was determined.

If said tables are available at every module, the determination of a shortest route is very simple. If the transported unit is situated in the current time window t₁=0 at the module m₁ and has the destination x, then the successor module is the module in the column t₁ of table distₓ^{m}^{₁}, and m₂ denotes the corresponding module. Furthermore, module m₁ specifies the entry time point and the entry time window t₂ for entry into the module m₂. These values are transferred, together with the previous route [m₁], to the module m₂. The module m₂ determines from column t₂ of the table distₓ^{m}^{₂} the successor module m₃, and the entry time point and the entry time window t₃ for entry into the module m₃. These values are transferred, together with the previous route, [m₁, m₂] to module m₃. Module m₃ and all the subsequent modules proceed similarly, until a module with the end point x is reached. If required, the route generated [m₁, m₂, m₃, . . . ] is communicated back to the module m₁.

The creation of the expanded direction tables will now be described by considering a simplified version. For this purpose, it is assumed that all passage times of a transported unit through a module are a multiple of the time window length. A module regularly updates the direction table thereof based on the direction tables of the immediate successor modules thereof. In concrete terms, it will be described below how, for a module m, the distance table distₓ^{m} to the destination x is updated. m₁, . . . , mₖ are the immediate successor modules to module m. The passage time through module m in time window t is nₜ multiplied by the time window length and dₜ is the length (value of the evaluation function) of module m in the time window t. The distance from module m to the destination x is then determined, if t is started within the time window, from

$${dist}_{x}^{m} ( t ) = {d}_{t} + {min}_{i = 1 … , k} {dist}_{x}^{{m}_{i}} ( t + {n}_{t} ) \qquad ( 1 )$$

wherein distₓ^{m}(t) denotes the distance entry in column t of the table distₓ^{m}. The value is ∞ if the destination x cannot be reached via the module. The successor module in column t of table distₓ^{m} is module mⱼ for index

$$j = arg {min}_{i = 1 , … , k} {dist}_{x}^{{m}_{i}} ( t + {n}_{t} ) \qquad ( 2 )$$

At the start of the section, reasons were given why it is not necessary that the routes determined are always exactly the shortest paths. Thus, the updates to the direction tables can take place for all modules, independently of one another in a regular rhythm. If the evaluation functions of the modules were not to change then, after some time, the direction tables would certainly contain the shortest paths.

What are the consequences if the passage times through the modules are not multiples of the time window length? In the expanded direction table method, this assumption concerning the passage times was implicitly used. On updating according to equation (1), the time window t+nₜ is used for the successor modules. This arises from the observation that a transported unit which reaches the module m at an arbitrary time within the time window t, will reach the successor module within the time window t+nₜ. This property no longer applies if the passage times are not multiples of the time window length.

For the selection of the entry time window of the successor module in equation (1), a particular start point within the time window t can be selected, for example, the mid-point. The time window t+nₜ is then that which corresponds to the entry of a transported unit into the successor module if the transported unit has reached the module m precisely in the middle of time window t. This concept is problematic if the passage times are smaller than half the window length. Given a sequence m₁, . . . , mₖ of modules with passage times smaller than half the window length, the method leads to unusable results. Δ is the window length, x is the end point of the module mₖ and the aim is the determination of the distance of module m₁ from x when starting in time window t=0. On updating the direction tables, each module mᵢ receives as nₜ the value 0.

This means that the entry distₓ^{m}^{₁} is the sum of all evaluations of the modules in the time window 0. If a transported unit enters module m₁ at time 0, then the passage times for three modules are not greater than 3Δ/2, although a value greater than 2Δ/2=Δ is possible. I.e. the module m₄ is then reached in time window 1.

Along the sequence m₁, . . . , mₖ, these errors accumulate and thereby cancel out the effect of the evaluation function.

The accumulation of errors can be reduced and the behavior just described can be prevented if the time window for entry into the successor module is determined in a somewhat more complex manner. m₁ and m₂ are two successive modules and τ is the passage time through the module m₁. FIG. 6 illustrates the temporal position of the prediction windows of modules m₁ and m₂ when the passage time τ is shorter than the time window length Δ.

A transported unit loaded into module m₁ at the start of time window 0 reaches the module m₂ τ time units later. Therefore, the time windows of module m₂ are displaced by τ time units relative to the time windows of m₁. The transition time point of time window 0 to time window 1 at module m₂ divides the time window 0 of module m₁ into two parts p and q. Transported units which are loaded into module m₁ in section p or q, reach module m₂ in time window 0 or 1. Assuming evenly distributed loading times in module m₁, a proportion p/Δ or q/Δ of the transported units reach module m₂ in time window 0 or 1. Applied to equation (1), as a minimum, the term distₓ^{m}^{ᵢ} (t+mₜ) is replaced with

$$\frac{{p}_{i}}{Δ} {dist}_{x}^{{m}_{i}} ( t + {m}_{t} ) + \frac{{q}_{i}}{Δ} {dist}_{x}^{{m}_{i}} ( t + {m}_{t} + 1 ) ,$$

where pᵢ and qᵢ are the parts into which the time window t of module m is disassembled by time window t+mₜ and t+mₜ+1 of module mᵢ. The end result is the following new equation

$${dist}_{x}^{m} ( t ) = {d}_{t} + {min}_{i = l , … , k} \{ \frac{{p}_{i}}{Δ} {dist}_{x}^{{m}_{i}} ( t + {m}_{t} ) + \frac{{q}_{i}}{Δ} {dist}_{x}^{{m}_{i}} ( t + {m}_{t} + 1 ) \} \qquad ( 3 )$$

The method described above corresponds to an essentially direct transfer of the Dijkstra algorithm for determining the shortest routes to a distributed method. If this method is used in a dynamic environment, such as the case examined here, then a phenomenon known as “looping” occurs. In order to avoid “looping”, depending on the emphasis of the boundary conditions, different expansions of the distributed labeling algorithm have been developed, for example, the OSPF routing protocol for the internet.

Assignment and Coordination of the Routes

The assignment of a route to a transported unit can be accomplished by different means. Examples are given below.

Variant 1

The simplest variant is the explicit storage of the route at the transported unit, for example, on an RFID tag or a software agent assigned to the transported unit. In decentralized installations, this procedure is unfavorable. A more natural approach in decentralized installations is decentralized storage. If each transported unit has an unambiguous ID within the material flow installation, then said ID can be utilized. When calculating the route for a transported unit, for example, with expanded direction tables, each set of points notes to which successor module the relevant ID should be passed on. This procedure can be combined very well with the cyclic information/decay process.

For this, apart from the ID and the direction, the set of points also stores the latest confirmation time point of the route. With every item of information from a transported unit concerning the route utilization for the purpose of prediction creation, the confirmation time point for the relevant ID is also updated. If the confirmation time point of an ID is further back than the cycle length of the information/decay process, the entry is deleted. Every set of points therefore has a routing table, indexed according to ID, which is used for the selection of direction for the transported unit and also for the creation of the prediction.

Variant 2

If each transported unit does not have a unique ID within the installation, then expansion can be undertaken with conventional routing tables in order to access a temporal component. The prediction creation does not, in principle, require any precise assignment of a route to a transported unit. What is made use of is only that, following a set of points, within a time window, all the transported units with the same destination are distributed over the successor modules in a fixed proportion (within a time window, transported units with the same destination can be exchanged on their remaining route). It is therefore sufficient if, within a time window, a set of points distributes the transported units with the same destination over the successor modules according to a key. I.e. when determining a route by means, for example, of expanded direction tables, the set of points must only note a counter, and the validity thereof, for a transported unit. After expiry of the validity, the counter is deleted again. In order for the transported unit to be further taken into account in the prediction, said transported unit must initiate a new determination of the route therefor.

A routing table expanded with a temporal component is, in this case, a stand-alone routing table for each future time window. The routing table of the current time window is used, in the conventional sense, by the control device for the transported units currently to be routed. The values of the routing table for a time window are given by the aforementioned counters. For example, there are two possible successor modules m₁, m₂ from module m to destination x and there are n₁ or n₂ counters for this purpose. The routing table of the corresponding time window is to be initialized such that a proportion n₁/(n₁+n₂) of transported units is routed via module m₁ and a proportion of n₂/(n₁+n₂) is routed via module m₂.

The routing tables for the future time windows are therefore suggestions for the routing tables to be used by the control device when the relevant time window is started upon. However, until the future time window is started upon, the routing tables can still change. Contrary to the variant with IDs, the route in the case without IDs remains in force for longer. In the first case, the validity of a route corresponds to the cycle length of the information/decay process which is smaller than the recalculation cycle for the routes. This difference has effects only in special situations, such as diverted transported units or failed modules.

The method described avoids the described disadvantages of methods that have to be adjusted based on different loading scenarios. At the same time, the method anticipates the future installation states and counteracts the occurrence of unbalanced loads through the route selection of said method. An adjustment, according to the actual installation, entails only three values: the selection of the time window size, the maximum number of time windows to be predicted in the future and the length of the cycles in which the predicted values are scaled or the information is distributed over the currently assigned routes.

Furthermore, the method is usable both in centrally and decentrally controlled installations. Particularly in decentrally controlled installations, the dispensing with installation-specific parameters is significant. As a result all the advantages of decentralized installations, such as reduced engineering effort, rapid commissioning, etc., are retained, together with effective routing, as in centrally controlled installations.

The method enables, in a simple way, transported units that are to be loaded in future to be taken into account. This also applies for decentrally controlled installations.

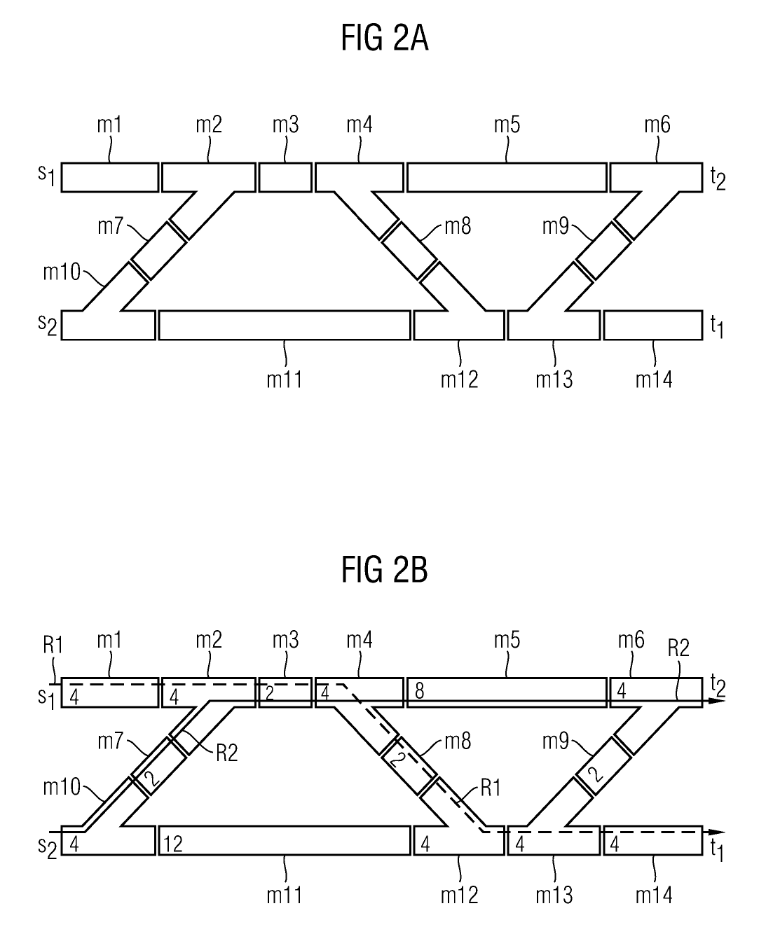

FIG. 2 shows an example of an installation with modules m1-m14 of a material flow system (e.g. a luggage conveying system in an airport). The modules m1-m14 can be, for example, conveyor belts, points or junctions. In the upper partial figure A) of FIG. 2, an example of an installation with modules m1-m14 is shown and, in the lower partial figure B) of FIG. 2, the respective passage times for the modules m1-m14 are given as well as possible routes R1, R2 from a start point s₁, s₂ to a destination point t₁, t₂.

The method will now be described using the example of the simple installation shown in FIG. 2. In principle, the figure could be considered to represent a section of a larger installation, and the sequences would not be altered at all thereby. Two types of transport tasks are to be fulfilled: tasks from s₁ to t₁ (dashed line, R1) and tasks from s₂ to t₂ (continuous line, R2).

Firstly, some technical assumptions regarding the installation: The installation consists of 14 modules m1-m14. All the modules m1-m14 should run at the same speed of 1 m/s and all the luggage items (transported goods, transported units) have a length, together with the minimum distance from the next luggage item, of 1 m. The passage time for a transported unit through a module is given in the lower section B) of FIG. 2, for example, 4 sec for module m1 or m10 and 2 sec for module m3 or m7. If the shortest sᵢ-tᵢ-routes are calculated for i=1, 2, regarding passage time, then the routes marked R1 and R2 in the lower partial figure B) of FIG. 2 are obtained.

The three installation-related parameters are selected as follows: The time windows have a size of 10 sec and the maximum number of time windows is sufficient, at 4, to cover the temporally longest route, and the cycle length for updating the prediction values is 5 sec. Transported units are to be loaded into the installation at s₁ and s₂ every 2 sec, starting at time 0. These parameters, like the passage times for the modules are given by way of example and serve to illustrate the method.

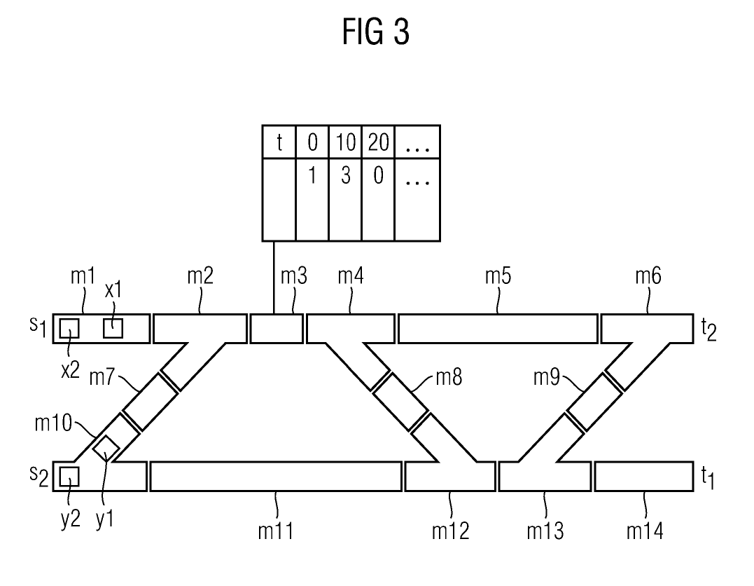

In FIG. 3, the state of the installation at time t=2 is shown. Four transport tasks are underway in the installation. Two are for the transport of transported units x1 and x2, and two further transport tasks for the transport of the transported units y1 and y2. The positions of the transported units x1, x2, y1, y2 in the installation are shown schematically. The situation at module m3 will be considered more closely by way of example. In FIG. 3, the prediction value for the first three time windows is given to the table via module m3 (and for clarity, in the first line of the table, in place of sequential numbers, the start of the time window is given). The 1 in the first time window originates from the loading of the transported unit x1, whilst the 3 in the second time window originates from the loading of the three transported units x2, y1 and y2.

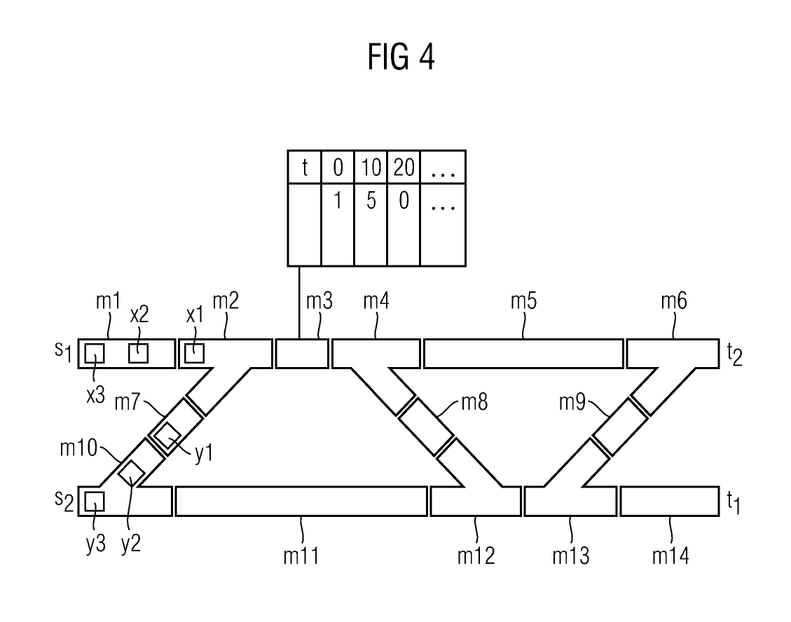

FIG. 4 shows the state of the installation (particularly the situation at module m3) at time t=4. Two further transported units, x3 and y3, have been loaded. Both transported units contribute to increasing the prediction at module m3 in the second time window. In the second time window (t=10), a 5 therefore appears (for the predicted 5 transported units at the time point t=10 at module m3).

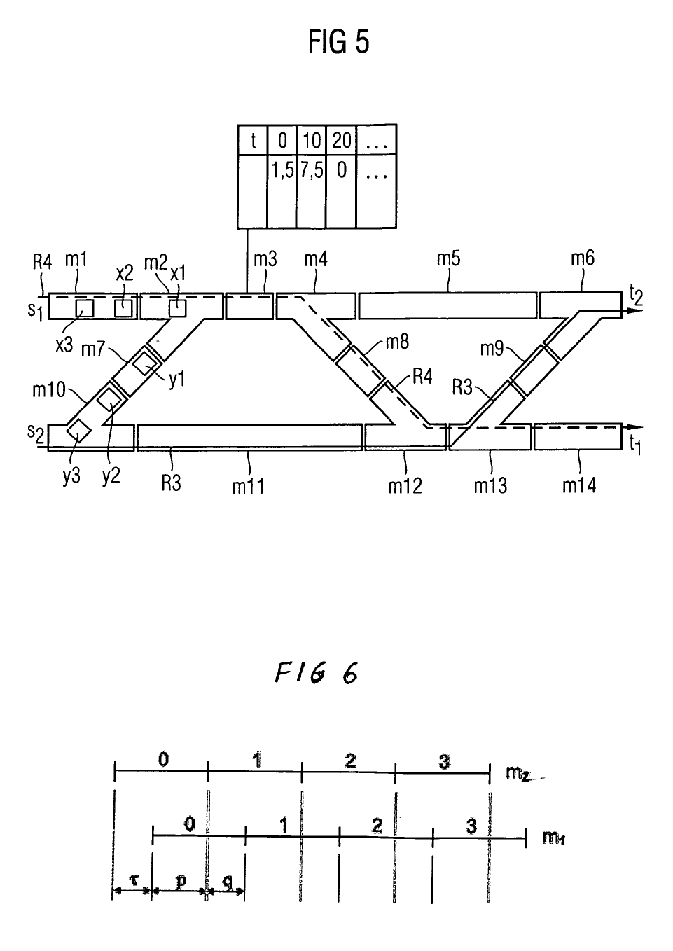

In FIG. 5, the state of the installation at time t=5 is shown. At time t=5, the first update takes place. For the sake of simplicity, it is assumed that first all the modules scale the prediction values thereof by ½ and then all the transported units notify the current route selection of each again. Following the scaling, the table receives from module m3 for the first two time windows, the values 0.5 and 2.5. The expected arrival time of x1 at the module m3 also falls within the first time window, whilst the remaining modules are all expected in the second time window. I.e. the corresponding values increase by 1 or 5, as shown in the table for module m3 in FIG. 5.

The module m3 has a calculated maximum capacity of 10 transported units (e.g. items of luggage) within a time window of 10 sec. Assuming 80% thereof as the maximum desirable load, then this amounts to 8 transported unit per time window. The predicted capacity utilization of module m3 at time t=5 amounts in the time window 10-20 to over 90%, x=7.5/8=0.934. Using the evaluation function

$$f ( x ) = \frac{x}{1 - x} ( x < 1 ) \qquad ( 4 )$$

the result is penalty costs of f(7.5/8)=15 for the module m3 in this time window. I.e. on re-calculation of the shortest routes from sᵢ to tᵢ for i=1.2, the routes R3, R4 shown in FIG. 5 are found. The next transported unit y4 to be loaded at time t=6 from s₂ (start point) to t₂ (destination point) is then assigned the new route R3, avoiding module m3.

The time t=5 is also the first time point at which an updating of the assigned routes can occur. However, the transported units x1 and y1 concerned are situated at a position from which there is only one route to the destination. Therefore the assigned routes will not change. This example, with the plurality of results at time t=5, shows that it is advantageous not to configure the cycles for new determination of the assigned route deterministically. Since the cycle for new determination of the assigned route has no influence on the correctness of the prediction calculation, said cycle can be selected arbitrarily. It therefore suggests itself to select the time to the next re-calculation randomly.

The evaluation function forms a core element of the method in the prevention of jam situations in material flow systems. Said function controls which routes are used for transport tasks within the current prediction. The evaluation function consists of two parts:

1. the standard passage times for the modules, and

2. a penalty component per module which is determined from the predicted number eₘ(t) of transported goods in the expected entry time window t of the goods in module m.

Given that P is a route and m₁, . . . , mₖ are the modules passed through along this route, then the evaluation function w(P, t) for the route is determined as

w(P, t)=w₁(P)+w₂(P, t)

where t denotes the time point of the start of the transported unit along the route P. The first term w₁(P) denotes the standard passage time for the route P and w₂(P, t) is the associated penalty component. As a result of the penalty component, the evaluation function w(P, t) is dependent on the time window t, at which the transported unit will enter the first module m₁ of the route P.

The first component w₁(P) is given by the sum

w₁(P)=w₁(m₁)+ . . . +w₁(mₖ)

where w₁(m) is the standard passage time of a transported unit through the module m.

The second part w₂(P, t) of the evaluation function, the penalty component, is more complex. w₂(P, t) is a function which, dependent on the prediction for the number of transported goods in a particular time window, stipulates the penalty costs for said time window and module. In contrast to w₁(P), the function is therefore additionally parameterized with the time point t at which the transported unit is situated at the start point of the route P. t=t₁, . . . , tₖ are the expected arrival time windows of the transported unit at the modules m1, . . . , mk along the route P. (In the case of penalty-free operation, the time windows tⱼ, j=1, . . . , k, are therefore the time windows associated with the time points t+Σᵢ₌₁^{j-1}w₁(mᵢ)). Furthermore, w₂(m, t) denotes the penalty costs for module m, if used in time window t. Then the second component is given by

w₂(P, t)=w₂(m₁, t₁)+ . . . +w₂(mₖ, tₖ)

In an ideal case, the prediction eₘ(t) for the module m in the time window t is always smaller than the maximum possible number uₘ of transport goods that the module m can accept within a time window. A function which, when approaching the maximum value, tends toward infinity suggests itself as the evaluation function w₂(m, t). If x=xₘ(t)=eₘ(t)/uₘ is the relative utilization of the module m in the window t under consideration, then

$$f ( x ) = \frac{x}{1 - x}$$

is a suitable function; w₂(m, t)=xₘ(t)/(1−xₘ(t)). Since the prediction is not determined in the context of a precise calculation of the expected transported goods, the relative utilization x can also be greater than 1. The function f(x) must be adapted accordingly, for example, for x>x₀ (x₀=a threshold value<1) f(x) can be replaced with the linear approximation of f(x) at the site x=x₀

$$\tilde{f} ( x ) = \{ \begin{matrix}f ( x ) & x \leq {x}_{0} \\ f ( {x}_{0} ) + {f}^{′} ( {x}_{0} ) \cdot ( x - {x}_{0} ) & x > {x}_{0}\end{matrix}$$

Altogether, in this case, for the evaluation function w₂(m, t), expressed in the values of the prediction eₘ(t), the following applies

$${w}_{2} ( m , t ) = \{ \begin{matrix}\frac{{e}_{m} ( t )}{{u}_{m} - {e}_{m} ( t )} & {e}_{m} ( t ) \leq {x}_{0} {u}_{m} \\ \frac{{x}_{0}}{1 - {x}_{0}} + \frac{{x}_{m} ( t ) - {u}_{m} {x}_{0}}{{{u}_{m} ( 1 - {x}_{0} )}^{2}} & {x}_{0} {u}_{m} < {e}_{m} ( t )\end{matrix}$$

for an arbitrary threshold value x₀<1.

The route for a single transported unit to a destination is determined in principle as the shortest route to the destination, wherein further auxiliary conditions possibly have to be taken into account. For example, in many material flow systems, certain conveyors do not convey all the types of transported goods, due to having too little headroom. For this purpose, any type of shortest route calculation is suitable, e.g. the Dijkstra-based labeling algorithms. Less well suited are algorithms which use pre-calculated data for passage time improvement, since said data must constantly be re-calculated due to the temporal dynamics of the evaluation function.

As described above, the evaluation function takes account of the expected loading of the modules at the expected entry time point of the transported unit. The expected loading of the modules changes with the loading on of new transported units or the transport of the units situated in the installation. In order to take account thereof, the routes of the transported units are re-calculated at regular intervals. In order to prevent oscillation in the route selection, the routes are not to be changed in a fixed rhythm. It would be better to toss a coin for a transported unit in a fixed rhythm and only to determine the route anew given a ‘heads’. The probability of ‘heads’ or ‘tails’ does not have to be ½ in each case, but rather can be an arbitrary pair (p, 1-p) of probabilities for 0<p<1.

The choice of a route only assigns this route to the transported unit. In particular, there is no direct coupling between the choice of the route for a transported unit and the prediction value of the module contained within the route. The prediction values are changed directly with the process described in section 2.2. Therefore the changing of a route for a transported unit also leads to no further updating, as is necessary, for example, on use of a reservation/clearance method.

Methods for determining the routes of transported units, particularly in material flow systems (e.g. luggage conveying systems in airports), wherein a prediction is created as to how many transported units arrive within the time window for each module (e.g. sets of points, conveying path), wherein an evaluation function is created, based on the prediction for each module, wherein an edge weight is assigned to each module depending on the load predicted for said module within the time window, and wherein for each transported unit (e.g. luggage item) in chronological sequence, a route is determined. The method enables automation of the fine adjustment (tuning) of an installation according to the actual and expected load situation.

### Reference Characters

SK1, SK2 Control component

SE Sensor

AK Actuator

AZ1, AZ2 Installation state

EP Loading plan

SP Control parameter

SO1, SO2 Control optimizer

ES1, ES2 Internal simulator

M, m1-m14 Module

x1-x3 Transported unit

y1-y3 Transported unit

R1-R4 Route

What is claimed is:

1. A method for determining the route of transported units, particularly in material flow systems, comprising the following steps:
a) Modeling the material flow system in modules which each represent physical elements of the material flow system, wherein a number of transported units that should reach a module within a specifiable time window is assigned to said module;
b) Making a prediction of how many transported units arrive at each module within the time window;
c) Creating an evaluation function based on the prediction for each module, wherein an edge weight is assigned to each module, depending on the predicted load thereof within the time window; and wherein
d) For each transported unit, sequentially, a route is determined, wherein the route is the shortest possible path, based on the edge weight of the module.

2. The method according to claim 1, wherein each transported unit is assigned a route in chronological sequence.

3. The method according to claim 1, wherein each transported unit is assigned a route in chronological sequence, based on the values from the routing tables assigned to the modules, wherein each routing table is dependent on the time.

4. The method according to claim 1, wherein the method is repeated at irregularly clocked intervals.

5. The method according to claim 1, wherein the prediction is made based on a cyclical information process and an exponential decay process.

6. The method according to claim 1, wherein for the prediction creation, the current route of a transported unit is fixed in a specifiable clock rhythm and that for all modules along the route, in the expected arrival time window for the transported unit, the prediction is increased by 1, and wherein, in the specified clock rhythm, for all modules, the prediction is multiplied by 0.5.

7. The method according to claim 1, wherein for the prediction creation, the current route of a transported unit is fixed in a specifiable clock rhythm and for all the modules along the route, in the expected arrival time window for the transported unit, the prediction is increased by 1, and wherein, in the specified clock rhythm, for all modules the prediction is multiplied in chronological order with values s₁ to sₖ, where 0.5<sᵢ<1 (i=1 . . . k), and the product s₁* . . . *sₖ is equal to 0.5.

8. The method according to claim 1, wherein the evaluation function for creating the edge weight is made up from an expected standard passage time of a transported unit to be expected at the module and a penalty component per module, which is determined from the predicted number of transported units in the expected entry time window of the transported unit at the module.

9. The method according to claim 1, wherein the shortest route for a transported unit is determined by the A* algorithm, the Dijkstra algorithm, the Bellman-Ford algorithm, the Floyd-Warshall algorithm or the Johnson algorithm.

10. The method according to claim 1, wherein a shorter or the shortest route for a transported unit is determined, based on distributed algorithms for determining or approximating shortest routes.

11. The method according to claim 1, wherein a module consists of a self-contained unit with regard to actuators, sensors and control device and comprises an internal simulator for determining a capacity utilization prediction for the module, wherein the module can exchange data with the predecessor and successor modules thereof, and wherein the capacity utilization prediction for the module is calculated on the basis of the entry time points of the transported units to the module supplied by the predecessor modules.

12. The method according to claim 1, wherein the module passes on to the successor modules the time points of the exit from the module of the transported units as predicted by the internal simulator.

13. A method for determining routes of transported units comprising the following steps:
a) Modeling the material flow system in modules, each of which represents physical elements of the material flow system, wherein a time-dependent routing table is assigned to a module, wherein, for each destination point of a transported unit, the routing table contains the next module on the route to the destination, or the information that the destination point cannot be reached; and
b) Updating the routing tables.

14. The method according to claim 13, wherein the updating of the routing tables is carried out with precise or approximate algorithms for determining the shortest route.

15. The method according to claim 13, wherein the updating of the routing tables is carried out by internal simulation.

16. The method according to claim 13, wherein the time-dependent routing table is characterized in that the information concerning the next module on the route to the target is dependent on the time point at which the transported unit is to be passed on to said module.

17. A material flow system for determining the route of transported units comprising:
modules modeling the material flow system, wherein the modules each represent physical elements of the material flow system, wherein a number of transported units that should reach a module within a specifiable time window is assigned to said module;
means for predicting of how many transported units arrive at each module within the time window;
means for creating an evaluation function based on the prediction for each module, wherein an edge weight is assigned to each module, depending on the predicted load thereof within the time window; and
means for determining for each transported unit, sequentially, a route, wherein the route is the shortest possible path, based on the edge weight of the module.

18. A material flow system for determining routes of transported units comprising:
modules modeling the material flow system, each of which represents physical elements of the material flow system, wherein the system is configured ti assign a time-dependent routing table to a module, wherein, for each destination point of a transported unit, the routing table contains the next module on the route to the destination, or the information that the destination point cannot be reached; and
means for updating the routing tables.

19. The system according to claim 17, wherein for the prediction creation, the system is configured ti fix the current route of a transported unit in a specifiable clock rhythm and that for all modules along the route, in the expected arrival time window for the transported unit, the prediction is increased by 1, and wherein, in the specified clock rhythm, for all modules, the prediction is multiplied by 0.5.

20. The system according to claim 17, wherein for the prediction creation, the system is configured to fix a current route of a transported unit in a specifiable clock rhythm and for all the modules along the route, in the expected arrival time window for the transported unit, the prediction is increased by 1, and wherein, in the specified clock rhythm, for all modules the prediction is multiplied in chronological order with values s₁ to sₖ, where 0.5<sᵢ<1 (i=1 . . . k), and the product s₁* . . . *sₖ is equal to 0.5.
